(19) United States
(12) Patent Application Publication
(10) Pub. No.: US 2017/0307205 A1
(43) Pub. Date: Oct. 26, 2017

(54) LAYERED REFLECTIVE STRIP, ARTICLE, AND/OR GARMENT, AND METHODS FOR INTEGRATING ELECTRONIC AND/OR ELECTRICAL COMPONENTS FOR IMPROVING AWARENESS, SAFETY, AND/OR VISIBILITY

(71) Applicant: SEKE LLC, Libertry, KY (US)

(72) Inventors: Seth MCBEE, Lexington, KY (US); Kevin WINZER, Lexington, KY (US)

(21) Appl. No.: 15/645,509

(22) Filed: Jul. 10, 2017

Related U.S. Application Data
(63) Continuation of application No. 14/669,270, filed on Mar. 26, 2015, now abandoned.
(60) Provisional application No. 61/971,217, filed on Mar. 27, 2014.

(51) Int. Cl. F21V 33/00; G08B 5/00; G02B 5/136; F21V 23/04; F21V 23/00; F21S 8/10; H05B 33/08; F21L 14/00

(52) U.S. Cl. CPC F21V 33/0008; H05B 33/08; G08B 5/004; G02B 5/136; F21L 14/00; F21V 23/0407; F21V 23/004; F21S 48/30; F21V 23/045

(57) ABSTRACT

The disclosure provides for a visibility safety strip device, articles, garment, and applications thereof. The disclosure also provides for a lightweight and ultra-bright visibility safety strip and associated methods of promoting the visibility of the wearer, for example, in low-light environments. The disclosure provides for a safety garment that utilizes a specific performance fabric structural under layer, overlaid with a technical retroreflective film to indicate a passive visibility. In an aspect the disclosure also provides for an embedded custom color and functionality light emitting diode (“LED”) and/or organic light-emitting diode (“OLED”) to refract light through the retroreflective film to indicate an active visibility.

### CROSS REFERENCE TO RELATED APPLICATIONS

This application is a Continuation of U.S. application Ser. No. 14/669,270, filed Mar. 26, 2015, which claims priority to U.S. Provisional Application No. 61/971,217, filed Mar. 27, 2014, the contents of which are incorporated by reference herein in their entirety.

### FIELD

The disclosure provides for a visibility safety strip device, articles, garment, and applications thereof. The disclosure also provides for a lightweight and ultra-bright visibility safety strip and associated methods of promoting the visibility, awareness, and/or safety of the wearer, for example, in low-light environments. The disclosure provides for a safety garment that utilizes a specific performance fabric structural underlayer, overlaid with a technical retroreflective film to indicate a passive visibility. In an aspect the disclosure also provides for an embedded custom color and functionality light, for example, a light emitting diode (“LED”) and/or organic light-emitting diode (“OLED”) to refract light through the retroreflective film to indicate an active visibility.

### BACKGROUND

There is a need for a lightweight and ultra-bright visibility safety strip, article, garment and associated methods for promoting the visibility of the wearer, for example, in low-light environments. Currently there exists reflective technology as well as lights to facilitate visibility of individuals. However, a safety strip, article, and/or garment that adequately incorporate both reflective technology and active light-based technology in a manner that is sufficient to identify an individual under low-light environments is lacking. There is an additional need for the customization of said active lighting source to appeal to personal preferences or needs and especially tailored for various industries where visibility is characteristic to the profession. There is a need for a versatile technology so that more pedestrians and workers desire to be noticed, whether it be for preference, requirement, attention, or some combination to integrate visibility safety with customization.

### SUMMARY

In an aspect, the disclosure provides for an article, strip, garment, or vest including:
a) a material under layer;
b) a retroreflective material, optionally comprising a structural backing layer to reflect oncoming light for increased visibility;
c) an LED(s) and/or OLED(s) light source between said material under layer and said retroreflective film layer; wherein said LED(s) and/or OLED(s) light source refracts light through said retroreflective material and increases active visibility;
d) optionally a single-color lighting or color fluctuation lighting;
e) optionally an LED(s) and/or OLED(s) light source connected to a mobile power source comprising a battery pack or connection to a signal or power supply of a transportation device;
f) optionally a wired and/or a portable controller or bluetooth receiver to allow for user inputs to control one or more of the following features selected from the group consisting of power-on, light color selection or cycling, blinking mode-on, power-off, dimming, and flash/blink speed; and
g) optionally a pre-programmed or customizable custom color combination.

The disclosure also provides for a method of improving the visibility of an individual, group of individuals, or object, by equipping, surrounding, or dressing an individual, groups of individuals, or object with an article including:
a) a material under layer;
b) a retroreflective material, optionally comprising a structural backing outer layer to reflect oncoming light for increased visibility;
c) an LED(s) and/or OLED(s) light source between said material under layer and said retroreflective film layer; wherein said LED(s) and/or OLED(s) light source refracts light through said retroreflective material and increases active visibility;
d) optionally a single-color lighting or color fluctuation lighting;
e) optionally an LED(s) and/or OLED(s) light source connected to a mobile power source comprising a battery pack or connection to a signal or power supply of a transportation device;
f) optionally a wired and/or portable controller or bluetooth receiver to allow for user inputs to control one or more of the following features selected from the group consisting of power-on, light color selection or cycling, blinking mode-on, power-off, dimming, and flash/blink speed;
g) optionally a pre-programmed or customizable custom color combination; and
h) optionally importing inputs from an electronic sensor, mobile device and/or application, GPS, clock and/or timer, and/or some health, positioning, sound, and/or visual monitoring device to auto-determine individual or a string of diode power on/off, color, flash/blink speed, and/or brightness.

The disclosure also provides for a method improving the visibility of an individual or group of individuals, wherein the individual is needing or desiring improved awareness and/or visibility, including:
a) Emergency personnel;
b) Airport/airline personnel;
c) Military;
d) Construction/highway workers;
e) Utility workers;
f) Commercial vehicle drivers;
g) Waste management drivers/workers;
h) Mining workers;
i) Transportation workers;
j) Event staff or venue personnel;
k) Athletes (i.e. walkers, runners, hikers, cyclists, water sport athletes);
l) Other pedestrians (children, concert, sporting event, and/or party attendees.

In an aspect, a material under layer includes fabric. In yet another aspect, the retroreflective material includes a structural backing outer layer to reflect oncoming light for increased visibility. In yet another aspect, the structural backing outer layer comprises a thin PCB.

The disclosure provides for a an article, strip, garment, or vest including e) an LED(s) and/or OLED(s) light source connected to a signal input which is connected to a mobile power source comprising a battery pack or connection to a power supply of a transportation device.

The disclosure further provides for a an article, strip, garment, or vest including g) a pre-programmed or customizable custom color combination, wherein said pre-programmed or customizable custom color combination is modified for identifying emergency personnel, team colors, or other applications with defining color schemes.

In another aspect, the disclosure provides for a power supply of a transportation device optimized to respond to a motorcycle, car, snowmobile, jet ski, bicycle, Segway, or other vehicle lighting system such that article responds to running, signal, and brake lights.

In another aspect, the disclosure provides for a an article, strip, garment, or vest including:
a) A fabric under layer;
b) A retroreflective material, optionally comprising a structural backing outer layer to reflect oncoming light for increased visibility;
c) an LED(s) and/or OLED(s) light source between said fabric under layer and said retroreflective film layer; wherein said LED(s) and/or OLED(s) light source refracts light through said retroreflective material and increases active visibility;
d) a single-color lighting or color fluctuation lighting;
e) an LED(s) and/or OLED(s) light source connected to a mobile power source comprising a battery pack or connection to a power supply of a transportation device;
f) a portable controller or bluetooth receiver to allow for user inputs to control one or more of the following features selected from the group consisting of power-on, blinking mode-on, power-off, dimming, and flash/blink speed;
g) a pre-programmed or customizable custom color combination; and
h) optionally importing inputs from an electronic sensor, transportation device, mobile device and/or application, GPS, clock and/or timer, and/or some health, positioning, sound, and/or visual monitoring device to auto-determine individual or a string of diode power on/off, color, flash/blink speed, and/or brightness.
The patent or application file contains at least one drawing executed in color. Copies of this patent or patent application publication with the color drawing(s) will be provided by the Office upon request and payment of the necessary fee.

### BRIEF DESCRIPTION OF THE FIGURES

FIG. 1 sets forth a representative article according to the disclosure, wherein (1) includes a base material, such as a fabric, (2) sets forth an example light emitting diode (“LED”) and/or organic light-emitting diode (“OLED”) arrangement, (3) describes a reflective or retroreflective technical material, (4) sets forth a signal input, and (5) a power supply.

FIG. 2 sets forth a representative article according to the disclosure, wherein (6) includes an example signal input controller, (7) sets forth an example power supply, and (8) describes an example cutaway.

### DETAILED DESCRIPTION

The disclosure provides for an article, garment, devices, and methods for integrating a reflective material and an lighting system into a wearable form. In an aspect, the reflective material is “passive” and the lighting system is “active.” Passive visibility is a result of using the retroreflecitve outer layer (3), which is a pre-existing method for improving the visibility of the wearer by reflecting light at strategic angles when a light source is projected at it. The embedment of the lighting layer (2), for example a LED(s) and/or OLED(s) layer, allows for active visibility, which refracts the lighting system through the said retroreflective layer (3) to project light outward, to identify the wearer without the presence of a separate light source (basically increasing visibility when a headlight or some other light isn't available/possible). This combination ensures the wearer can be visible in the case of an available light, but also the added element for identifying oneself with powering a wearable lighting system.

In an aspect, the disclosure provides for an article, strip, or garment having a base layer of a material or fabric. Examples of fabric can include a moisture-wicking material, like scuba, performance material from Nike®, UNDER ARMOUR®, ADIDAS®, BROOKS®, ASICS® or others can also be used for sweat-producing applications, and a thicker nylon webbing material can also be used for industries requiring more durable materials. In another aspect, material can be adapted for associated comfortability and can also be sewn or otherwise modified into a prescribed form.

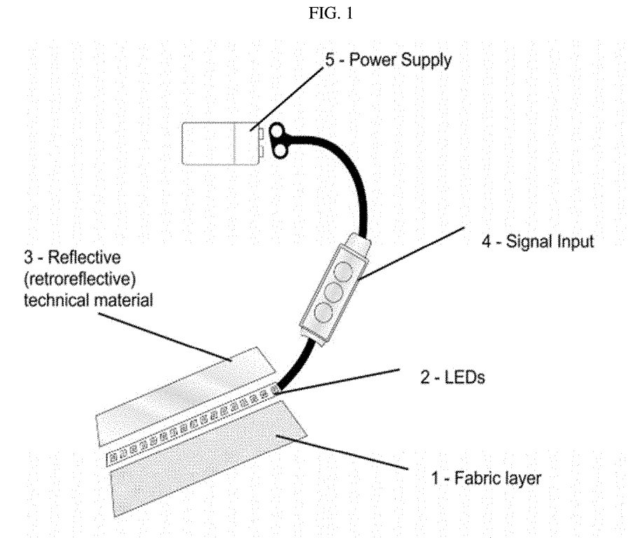

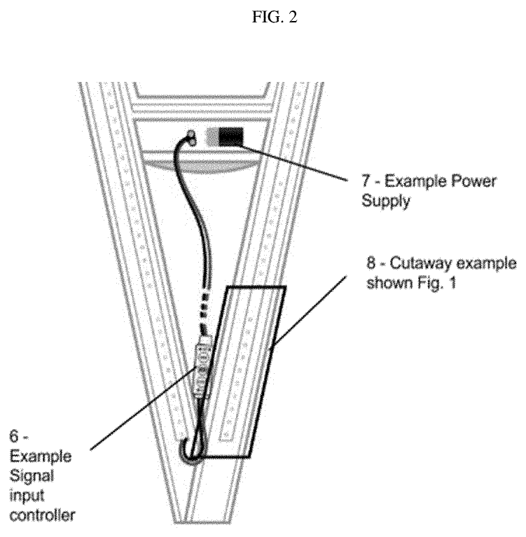

FIGS. 1 and 2 described herein depict various representative embodiments of the present disclosure. For example, FIG. 1 depicts an example view of different layers capable of being used in a strip, article, device, garment, or method described herein. In an aspect, the base material (1) can be fabric, for example, a fabric or material that exhibits performance enhancing characteristics. This can be a sweat-wicking material for athletes or other wearers, or a more durable material (i.e. nylon webbing) for uses that need more stiffness or being more robust. In an aspect, mounted on top of the fabric material (1) is a lighting source, for example, LED(s) and/or OLED(s) (2). This layer can also encompass electronic wiring or cabling. The disclosure also provides for an aspect where the lighting source, for example, LED(s) and/or OLED(s) are strategically light in weight and can have a variety of waterproofing capabilities, for example, epoxy, silicone mold, and/or contain a waterproof tubing surrounding. In another aspect, reflective or retroreflective technical material (3) can overlay the lighting source, for example, the LED(s) and/or OLED(s). This material can be along the lines of 3M®, Scotchlite®, retroreflective film or some similar vinyl or other reflective material that is thin and capable of encapsulating the LEDs to refract the lighting through its surface to illuminate the top of the strip. In another aspect, the underlayer (1) can be strategically wrapped around the edges of the retroreflective layer (3) in a way to soften the edges to moderate, improve, it prevent abrasion while also providing a seam to seal.

In another aspect, the disclosure provides for one or more layers on either side of the material layer (1). In another aspect, the disclosure provides for one or more, two or more, three or more, or four or more layers on either side of the material layer (1). In an aspect, the one or more, two or more, three or more, or four or more layers are fabric layers. In another aspect, the disclosure provides for one or more additional layers, for example reflective layers, on either side of the reflective layer (3). In another aspect, the disclosure provides for one or more, two or more, three or more, or four or more layers, for example, reflective layers, on either side of the reflective layer (3).

In an aspect, a lighting source, for example LED(s) and/or OLED(s), is not directly attached to either material layer (1) or reflective layer (3). In another aspect, a lighting source is not directly attached to either material layer (1) or reflective layer (3), but is rather embedded between these two layers as described herein. In an aspect, a lighting source is not directly attached to either material layer (1), but is attached to the reflective layer (3). In an aspect, a lighting source is not directly attached to either material layer (1), but is attached to the reflective layer (3) and is also embedded between the material layer (1) or reflective layer (3). The disclosure also provides for an aspect where the reflective layer is the outermost layer and is directly exposed or open to the environment. The disclosure further provides for an aspect where the reflective layer is the outermost layer and is directly exposed or open to the environment and the material layer, for example, the fabric layer is the innermost layer.

In an aspect, the reflect layer includes vinyl. In another aspect, the vinyl is the outermost layer of the reflective layer. In yet another aspect, the reflective layer includes a reflective vinyl and a PVC backing layer. In another aspect, the light layer as described herein is between, embedded, or channeled between the reflective vinyl and a PVC backing layer. In another aspect, multiple light layers may be embedded, or channeled between the reflective vinyl and a PVC backing layer. In yet another aspect, the light layer as described herein is between, embedded between, or channeled between the reflective vinyl and a PVC backing layer and also embedded between the material layer (1) or reflective layer (3).

The lighting, for example, the LED(s) and/or OLED(s) (2) can also be wired or connected in line to a lightweight signal device (4) and/or lightweight power source (5) as shown in FIG. 1. In an aspect, the signal can be an input via a switch or some receiver to identify the actions of the embedded diodes. Examples of input mechanisms can include press-button or toggle switches, bluetooth receiver from mobile smartphone, remote using infrared, radio frequency, RFID, or other similar signal that is capable of activating the input switch. The signal can identify the behavior of each and all diodes. Examples of custom behavior can be brightnesses, flashing speed, color mode, or actuating other attachments. These attachments can be microphone sensors, accelerometers, heart rate and salinity sensors, etc. One specific example is that the signal controller (4) can be programmed to cycle between user-selected speeds for red and blue light fluctuations, for example, in the case of emergency light solutions. Other colors or light patterns associated with emergency personal are also envisioned. These lights can also be altered to reflect team colors, for example, a professional, college, high school, corporate, or other sports team. Flash rates and brightnesses are significant for the purpose of battery power conservation or in specific industry applications.

In an aspect, FIG. 1 identifies a cutaway of the technology that has various layers that enable the wearer to harness a customized light system (2, 4, 5) and a retroreflective layer to refract that light to increase active visibility. In another aspect, FIG. 2 shows an embodiment of this technology in a reflective vest or garment. This vest or garment can include all the layers in FIG. 1 shown in a section cut (8), which can also be wired to a controller (6), which may be a user-selected button controller. This allows for the user to select various custom options, as in color, brightness, flashing frequency, or the signal for attachment electronic sensors or devices (i.e. microphone sensor). The electronic components in this embodiment can also be wired to a connector to a power source (7), which in an embodiment can be a lightweight 9V battery or other suitable power source. In an aspect, the wires or cables shall be either easily accessed for the connection of other electronic devices or for repairs or embedded in between the fabric (1) and retroreflective (3) layers to accommodate embedment, waterproof, or other strategic reasons.

In an aspect, the outer layer of the strip can be an retroreflective material. In another aspect, the retroreflective material can meet ANSI/ISEA 107-2004, or ANSI/ISEA 107-2010 or more recent or similar criteria standards for photometric requirements of retroreflective material and/or requirements of retroreflection and combined-performance materials, which include retroreflective. This can be useful for retroreflective materials that have been tested for folding/flexing and possibly at various temperatures, domestic washing, rain fall tests. These materials meet Class 3, 2, 1, E or headwear, but can also be tailored for the specific industry. Such a retroreflective material can have technical specifications for reflecting light at various angles and distances and also be adequate for visibility safety. In another aspect, the strip strategically can employ 2 inch strips of the material, for applications for garments (i.e. safety vests). In another aspect, the strip can employ about 1 to about 5 inch strips, about 2 to about 4 inch strips, about 0.5 to about 3 inch strips, about 1 to about 2 inch strips. The underlayer material, in an aspect, can be wrapped over the edges of the vinyl and adhered to soften the rigid edges of the vinyl retroreflective material. Another solution for sealing the layers can be a binding that is inherently comfortable to the touch.

In an aspect, in between the material (1) and retroreflective (3) layers is a specified number of a lighting source(s), for example an LED(s) and/or OLED(s). In an aspect, the disclosure provides from 1 to about 5 lights, from 1 to about 10 lights, from about 10 to about 30 lights, from about 20 to about 50 lights, from about 30 to about 60 lights, from about 30 to about 60 lights, from about 30 to about 90 lights, from about 30 to about 120 lights, from about 50 to about 100 lights, from about 60 to about 120 lights, or from about 120 to about 1000 lights. In an aspect, the disclosure provides for 1 light, about 10 or more lights, about 20 or more lights, about 30 or more lights, about 50 or more lights, about 60 or more lights, about 90 or more lights, about 100 or more lights, about 120 or more lights, about 150 or more lights, or about 200 or more lights. In an aspect, the lights are LED(s) and/or OLED(s).

In another aspect, the disclosure provides for LED strips, for example, waterproof LED strips. In another aspect, the LED strips are about 2-about 20 mm wide and about 0.5 to about 10 mm thick with about 10-20 lumen/SMD and/or about 10-20 lumen/SMD at about 10 to about 30 LEDs/m or about 10 to about 80 LEDs/m or about 80 to 120 LEDs/m with a viewing angle of about 100-200 degrees in the case of more than one LED aligned. In another aspect, the disclosure provides for LED strips, for example, waterproof LED strips about 10 mm wide and about 2 mm thick with about 16-18 lumen/SMD for high brightness and about 18-20 lumen/SMD for super brightness at 30 LEDs/m or 60 LEDs/m or 120 LEDs/m with a viewing angle of 160 degrees in the case of more than one LED aligned. This can be exceptionally beneficial for the SMD LEDs design which gives off low, nearly or substantially zero heat and allows for a large number, for example more than about 10, more than about 12, more than about 15, more than about 20, more than about 30, more than about 40, more than about 50, or more than about 100 lights to be situated on a thin, flexible circuit board. The strip in FIG. 1, for example, can use a LED strip on a PCB board to allow for a multitude of lights, for example more than about 10, more than about 12, more than about 15, more than about 20, more than about 30, more than about 40, more than about 50, or more than about 100 lights to shine using a single power source. These lights can include waterproof encasing if needed and can be wired to a lightweight power source like a battery, for example, a 9V battery pack, but any power source between 5V and 24V DC or AC. In another aspect, the lights are wired to a controller with embedded functions that alter the features of the light. These can be on, off, flashing, color-changing (for example, RGB LEDs), dimming, flash frequency, or other pre-programmed features. Some examples of the pre-programmed or even user-inputted lights can identify numbers, words, slogans, logos, trademarks, names, or any animation to the wearer's preference by integrating many LEDs, for example more than about 10, 12, 15, 20, 30, 40, 50, or 100 LEDs in an alignment conducive to the image, word, etc. projected through the outer material (3). These changes to the LED, and thus the article, can be made using a lightweight mini controller, remote, a transportation device's inputs, or using Bluetooth technology. The electronics of the prescribed embodiment can also be enhanced to be fully waterproof, submersible at various depths, and dust/dirt proof for applications in industries that require it.

In an aspect, integration of the article(s) or garment(s) of the present invention into any embodiment are preferably adapted to meet safety regulation in various countries including the regulations of ANSI/ISEA 107-2010 or similar. The article can be attached using sewing, gluing, wiring, or other method to any embodiment that does not meet the layered criteria (1), (2), (3). In any aspect just the reflective material (3) can cover any percentage of the created article, such as up to about 100%, up to about 75%, up to about 50%, up to about 25% of the exposed surface area. In a similar manner, the lighted system layer (2) can cover any percentage of the created article, such as about 100%, up to about 75%, up to about 50%, up to about 25%. In another embodiment, the garment created using the invention can be at a minimum approximately 10% reflective (3) and/or 10% covered in lights (2). Uses for the incorporation of the present invention can be in shirts, jackets, shorts, hats, headbands, bracelets, watches, backpacks or other bags, so long that there are elements of the fabric under layer (1), electronic lighting components (2), even in the case of a watch-face, and retroreflective material (3).

The strip, article, or garment described herein can be used in any embodiment, and not necessarily in two v-shaped portions, but can be designed for a wearer to enhance visibility in low-light conditions. This lends itself to having the strips sewn in a vest as shown in FIG. 2. The strips can also be sewn to shirts, shorts, pants, coats, etc. to produce any garment that now has customized reflective strips. This is especially useful in the application of using fluorescent clothing and incorporating said retroreflective material with embedded LED strips on top of the shirt to meet certain industry requirements.

The disclosure also provides for an article, device, garment, mechanism, or method that is versatile in design, especially in the use for its applications for improving the visibility of pedestrians or industry workers that inherently require a custom color, flashing frequency, or brightness. The LED strip technology can also be tailored to be red and blue flashing to identify emergency personnel; the lights can alternate between one or two or three or four colors to identify a specific sports or other team, which have representative colors; the lights can be selected to identify certain professions that inherently desire to be bright, for example, construction workers, air traffic controllers, event staff, security, other emergency personnel, miners, etc. This can be especially useful at a large event (i.e. festival, sports event, public gatherings) so that the proper personnel can activate their layered strip with said controller to refract the identifiable light so that people can quickly identify proper authority (i.e. blue for police, red for EMT, yellow for event staff, etc.). Methods for utilizing the articles, devices, or mechanisms described herein with the above-described population or groups are also provided for.

In an aspect, a visibility strip described herein can be electronically connected to a data collection system that can input or collect responses using a computer or handheld device. In one aspect, these programs can be used to communicate with an array of sensors depending on the use of the embodiment. Examples sensors can include, for instance, a microphone, accelerometer, heart rate monitor, salinity pedometer, or any other useful sensor that can collect and send data using electronic connections, probe, or signal.

The disclosure also provides for a device, handheld device, tablet, or computer application designed to input, receive, collect, and analyze electronic signals from sensors embedded on the inner or outer surfaces of the strip, article, or garment. This application can be configured to provide the user with intuitive metabolic feedback, while also offering the user the ability to select the color(s) and flashing or dimming with voice commands via a small microphone or through tactile selection via a smartphone. This user would have the option of selecting certain modes within the application that change the LED or OLED color, flashing and flashing speed, or brightness based on changes in the embedded electronic sensor feedback.

The articles, devices, or mechanisms described herein also useful for pedestrians and hobbyists that inherently prefer to be brighter, whether it be for attention, visibility safety, or both. Users can customize the aspects of their layered strip in a fashionable way that promotes wearing an item that promotes notice ability. This can be useful for runners, cyclists, dog walkers, children, concert-goers, or individual at any event. The embedded LEDs can be in any embodiment to fit the preference of the wearer. This is especially useful in case for increasing the functionality of the programmed lighting to spell words, numbers or simulate graphics using many rows of LEDs that can be different colors, flashing, brightness.

1. An article comprising:
a) a material under layer;
b) a retroreflective material comprising a structural backing outer layer to reflect oncoming light for increased visibility;
c) about 10 or more LED(s) and/or OLED(s) light sources between said material underlayer and said retroreflective film layer; wherein said LED(s) and/or OLED(s) light sources refract light through said retroreflective material and increase active visibility;
d) a single-color lighting or color fluctuation lighting;
e) a mobile power source comprising a battery pack or connection to a power supply of a transportation device, wherein said LED(s) and/or OLED(s) light sources are connected to the mobile power source;
f) optionally a portable controller or bluetooth receiver to allow for user inputs to control one or more of the following features selected from the group consisting of power-on, blinking mode-on, power-off, dimming, and flash/blink speed;
g) a pre-programmed or customizable custom color combination; and
h) optionally importing inputs from an electronic sensor, transportation device, mobile device and/or application, GPS, clock and/or timer, and/or some health, positioning, sound, and/or visual monitoring device to auto-determine individual or a string of diode power on/off, color, flash/blink speed, and/or brightness.

2. The article of claim 1, wherein said structural backing outer layer comprises a thin PCB.

3. The article of claim 1, wherein said pre-programmed or customizable custom color combination is modified for identifying emergency personnel, team colors, or other applications with defining color schemes, letters, symbols, numbers, words and/or sentences, icons, scrolling text if desired, logos, trademarks, etc.

4. The article of claim 1, wherein said article responds to running lights, signal lights, and brake lights of a motorcycle, car, snowmobile, jet ski, bicycle, Segway or other vehicle.

5. The article of claim 1, wherein said material under layer comprises fabric.

6. A garment comprising the article of claim 1.

7. The garment of claim 6, wherein said garment further comprises a retroreflective color outer layer, and the ability to have any color(s) LEDs embedded underneath, with inputs for flashing the prescribed color(s) at various speeds, and dimming capabilities.

8. The garment of claim 6, wherein the LEDs are controlled by an electronic controller.

9. The garment of claim 8, wherein said electronic controller comprises a tactile switch and/or a remote input.

10. The garment of claim 9, wherein said remote input comprises one or more of an electronic sensor, transportation device, mobile device and/or application, GPS, clock and/or timer, and/or some health, positioning, sound, and/or visual monitoring device to auto-determine individual or a string of diode power on/off, color, flash/blink speed, and/or brightness.

11. A method of improving the visibility of an individual, group of individuals, or object, comprising equipping, surrounding, or dressing said individual, group of individuals, or object with an article comprising:
a) a material under layer;
b) a retroreflective material comprising a structural backing outer layer to reflect oncoming light for increased visibility;
c) about 10 or more LED(s) and/or OLED(s) light sources between said material under layer and said retroreflective film layer; wherein a light emitted from said LED(s) and/or OLED(s) light sources refracts through said retroreflective material and increase active visibility;
d) a single-color lighting or color fluctuation lighting;
e) a mobile power source comprising a battery pack or connection to a power supply of a transportation device, wherein said LED(s) and/or OLED(s) light sources are connected to the mobile power source;
f) optionally a wired and/or portable controller or bluetooth receiver to allow for user inputs to control one or more of the following features selected from the group consisting of power-on, light color selection or cycling, blinking mode-on, power-off, dimming, and flash/blink speed; and
g) a pre-programmed or customizable custom color combination; and
h) optionally importing inputs from an electronic sensor, mobile device and/or application, GPS, clock and/or timer, and/or some health, positioning, sound, and/or visual monitoring device to auto-determine individual or a string of diode power on/off, color, flash/blink speed, and/or brightness.

12. The method of claim 11, wherein said individual is selected from the group consisting a fireman, policeman, EMT worker, doctor, construction worker, airport/airline worker, transportation worker, mining worker, plant/factory worker, Emergency personnel, military personnel, highway worker, utility worker, commercial vehicle driver, waste management driver/worker, event staff or venue personnel, or some other worker that needs ANSI, OSHA, or other overseeing body that requires workers to wear certain technical articles (e.g. safety vest).

13. The method of claim 11, wherein said individual is a pedestrian, wherein said pedestrian is optionally selected from the group consisting of a child, a sporting event attendee, a concert attendee, some other event attendee, walker, runner, cyclist, water sport athlete, or any individual needing or seeking improved awareness and/or visibility.

14. The method of claim 11, wherein said pre-programmed or customizable custom color combination is modified for identifying emergency personnel, team colors, or other applications with defining color schemes, letters, symbols, numbers, words and/or sentences, icons, scrolling text if desired, logos, trademarks, etc.

15. The method of claim 11, wherein said article responds to running lights, signal lights, and brake lights of a motorcycle, car, snowmobile, jet ski, bicycle, Segway or other vehicle.

16. An article comprising:
a) a fabric under layer;
b) a retroreflective material comprising a structural backing outer layer to reflect oncoming light for increased visibility;
c) about 10 or more LED(s) and/or OLED(s) light sources between said fabric under layer and said retroreflective film layer; wherein said LED(s) and/or OLED(s) light sources refract light through said retroreflective material and increase active visibility;
d) a single-color lighting or color fluctuation lighting;
e) a mobile power source comprising a battery pack or connection to a power supply of a transportation device to transmit electrical or other inputs via wired or remote connection, wherein said LED(s) and/or OLED(s) light sources are connected to the mobile power source;
f) a wired and/or portable controller or bluetooth receiver to allow for user inputs to control one or more of the following features selected from the group consisting of power-on, blinking mode-on, light color selection or cycling, power-off, dimming, and flash/blink speed;
g) a pre-programmed or customizable custom color combination; and
h) optionally importing inputs from an electronic sensor, transportation device, mobile device and/or application, GPS, clock and/or timer, and/or some health, positioning, sound, and/or visual monitoring device to auto-determine individual or a string of diode power on/off, color, flash/blink speed, and/or brightness.

17. The article of claim 1, wherein one or more of said LED(s) and/or OLED(s) light sources are color-changing light sources.

18. The article of claim 1, wherein said article comprises about 20 or more of said LED(s) and/or OLED(s) light sources.

19. The article of claim 1, wherein said article comprises about 100 or more of said LED(s) and/or OLED(s) light sources.
